(19) United States
(12) Patent Application Publication
(10) Pub. No.: US 2016/0368017 A1
(43) Pub. Date: Dec. 22, 2016

(54) Heated caulking gun

(71) Applicant: Grzegorz Dlugosz, River Grove, IL (US)

(72) Inventor: Grzegorz Dlugosz, River Grove, IL (US)

(21) Appl. No.: 14/544,068

(22) Filed: Nov. 20, 2014

(51) Int. Cl. B05C 17/005; F24J 1/00

(52) U.S. Cl. CPC B05C 17/00546; F24J 1/00

(57) ABSTRACT

A caulk heater for use with a caulking gun is provided. The caulk heater includes multiple layers. A heat transmissive interior surface layer is arranged to engage in a surrounding relationship with a caulking gun containing a caulk cartridge, to facilitate the transfer of heat to the caulk cartridge. The heated sleeve contains at least one pocket shaped and sized to receive standard, commercially available, disposable hand warmers, or similar material capable of producing heat without reliance on an outside power supply. A first exterior surface layer is made of a heat resistant, insulation material to minimize the loss of heat, and maximize the delivery of heat to the caulking cartridge. A protective second exterior surface layer can be made out of a durable material to generally protect the caulk heater from excessive wear and tear and from damage. A fastener is provided to removably enclose the caulking gun and the caulk cartridge.

### FIELD OF THE INVENTION

The present invention relates to caulking guns.

### BACKGROUND OF THE INVENTION

Caulking guns are well known in the art. Caulking guns are designed primarily for dispensing caulk and other similar substances that come prepackaged within a cylindrical-like container or cartridge. The caulking gun includes a trigger that extends a plunder into the cartridge, pushing out the caulk through an exit funnel opposite the plunder. While caulk has numerous uses, including hobbies and repair applications, it is used primarily in the construction of homes, buildings, marine vehicles, driveways, and variety of other projects. Caulk is commonly used by homeowners and construction professionals for sealing and securing various construction surfaces, joints, and seams. Caulk functions as a glue or filler between the surfaces to which it is applied, prohibits leakage of water through the area, to seal moisture out, and prevents mildew growth resulting from trapped moisture. Because of this, viscosity of the caulk at the time of application is important to the resulting strength of the seal once the caulk hardens. This is because the surfaces of all materials are, to varying degrees, porous. A porous surface, even microscopic, is better adhered to by a substance of optimal, or near optimal viscosity, because such substance is more able to enter the crevasses that make up the surface of the material. Once the caulk hardens, this infiltration into the surface provides a more watertight and stronger seal that is more resilient to wear, as well as the expanding and contracting caused by interior and exterior temperature changes.

Caulk may be dispensed and applied at variety of temperatures. When caulk is dispensed at optimal or near optimal temperature, it is generally soft and easily spread by hand pressure applied to the caulking gun trigger, adheres well to the surfaces to be bonded or sealed, and forms a strong and durable bond or seal. However, when the surrounding temperature falls below the optimal temperature, the viscosity of the caulk increases (the caulk becomes denser), making it more difficult for the caulk to be dispensed from the cartridge, and decreasing the ability of the caulk to penetrate and bond surfaces, and to effectively seal joints and seams. Even small temperature variations can cause the viscosity of the caulk to change within a short period of time, resulting in inconsistent applications, and preventing continuous, easy-to-control flow and application.

When the surrounding temperature falls significantly below the optimal temperature, i.e. to or below freezing, the caulk within the cartridge can become too dense to be dispensed from the caulk cartridge, or can harden within the cartridge. The caulk may become unworkable until the caulk is brought back to optimal or near optimal temperature. When the caulk becomes dense or hardens in the cartridge, extra force must be exerted by the user to cause the caulk to flow out of the cartridge. The user may become tired, due to having to exert the extra force, and in some cases injuries may even occur. This may cause the user to take frequent breaks from work to rest, or extended breaks to allow an injury to heal. The extra force may also cause the caulk cartridge to burst, rendering the caulk remaining in the cartridge unusable, and may require cleanup of the caulk that may have spilled around the job site from the cartridge.

Even if the caulk can be dispensed successfully and applied to the surface, the caulk may be too dense to effectively penetrate and/or bond to the surface, joint or seam, resulting in a weak and fragile bond or seal. Reapplication of the caulk to the same surface, joint or seam is time consuming and wasteful. The caulk is also susceptible to damage from freezing, leading to the loss of the caulk, and thus increasing the cost of the project.

Therefore, when the application of the caulk occurs in cold or freezing temperatures, the caulk should be kept at a temperature that is optimal or near optimal for application, and should be protected from freezing damage. The typical manner of keeping the caulk at optimal or near optimal temperature and protecting the caulk from freezing is to ensure that the caulk is not stored in an unheated area. However, merely storing the caulk in a heated area can be extremely inconvenient, especially when the caulk is applied in an outside area, when the job site is unheated or when the application of the caulk occurs at higher elevations accessed by a user on a ladder.

In many climates, these problems can significantly shorten the length of the season during which jobs requiring application of caulk may be performed, and thus may significantly affect the bottom line of individuals whose livelihoods depend on application of caulk. These problems may also be extremely inconvenient to a homeowner who may want, or who may be required, to perform repairs requiring the application of caulk during the cold season, for example, to seal cracks by window frames in winter.

Various devices have been suggested that attempt to keep the temperature of the caulk at an optimal or near optimal level prior to, and during, the application of the caulk in cold or freezing temperatures. One type of such devices involves the use of portable bag warmers or containers having an insulated housing, which utilize a heating pad connected to an outside power supply, to keep the interior of the bag warmer or container warm for storage of caulk cartridges.

Nevertheless such devices experience a number of drawbacks. One of the drawbacks is that these devices are not capable of keeping a caulk cartridge warm while the caulking gun is in use. Once the caulk cartridge is taken out of such device, heat is no longer supplied to the caulk cartridge to keep the caulk warm, and the temperature of the caulk within the cartridge begins to decrease. To prevent a significant drop in the temperature of the caulk, the user either dispenses all of the caulk in the cartridge within a short period of time, which may lead to sloppy and inconsistent applications, or the user periodically returns the caulk cartridge back to the bag warmer or container, to reheat the caulk, which requires time and causes work stoppage. It may also result in spillage of the unused caulk from the caulk cartridge in the bag warmer or container, when the caulk is returned to the bag warmer or container to be reheated, requiring cleanup.

Another drawback is that such devices rely on a constant source of alternating current (AC) in order to operate. Often, a job site will not be provided with AC power, rendering such devices incapable of operation. Even when AC power source is available, such devices may require the use of long extension cords, as the distance from the site of the application of the caulk to the site of the AC power source may be significant. Devices that are battery operated may nevertheless require an AC power supply in order to keep the battery sufficiently charged throughout the day.

Another drawback is that such devices are generally large in size, and inconvenient and difficult to carry around the job site. This may particularly be the case when the application of the caulk must be done on higher elevations, requiring access by ladder. It may be impossible for the user to have a readily available supply of caulk cartridges, because the user will likely be unable to carry the device up the ladder to the application site.

Another type of such devices involves the use of electric heated caulking guns. Such devices typically utilize an electric resistance heating element lined on or around the base of the caulking gun to supply heat to the caulking gun and the caulking cartridge. A power cord is connected to the heating element for providing power from external source. Alternatively, such devices can also be battery operated.

However, such devices also experience a number of drawbacks. One of the drawbacks is that these devices also rely on a constant source of AC in order to operate. Accordingly, either a power cord or a battery must be used to provide power to the device. If a job site is not provided with an AC power source, such devices may be inoperable.

Another drawback of such devices is that they are difficult to operate. Due to the extra weight added to the caulking gun by the elements of the heating mechanism, the applicant may have to use two arms just to hold such a device. Problems may especially occur when the application of caulk occurs at higher elevations, where the applicant may have to use one arm for support on the ladder. In addition, in devices that utilize power cords to connect to a power supply, the power cord may make it further inconvenient to operate the caulking gun.

Still another drawback of such devices is that the heating mechanism generally cannot be moved from one caulking gun to another. Thus, if an element of such a device breaks, for example the trigger of the caulking gun, the caulking gun together with the heating mechanism may become inoperable, forcing the user to purchase another such device to continue application of the caulk. Likewise, a malfunction in an element of the heating mechanism may cause the device to become incapable of supplying heat to the caulking gun, likely preventing the application of the caulk in cold or freezing temperatures, requiring replacement of the device in order to continue work.

Another drawback of such devices is that they are generally expensive to manufacture and thus generally expensive for users to purchase, increasing the overhead cost associated with work involving application of caulk in cold or freezing temperatures.

Thus, what would be desirable would be a device capable of providing heat to a caulk cartridge mounted on a caulking gun without the use external power supply or batteries. It would further be desirable for the heating source of the device to be capable of being replaced in an easy and expedient manner, to allow for a near continuous operation of the caulking gun. It would also be desirable for the device to be portable to allow the user to move freely around the jobsite with minimal additional effort. It would also be desirable for the device to be compatible for use with caulking guns of various designs, manufacturers and sizes. It would further be desirable for the device to be capable of being separated from the caulking gun, to be mounted on another caulking gun. It would further be desirable for the device to be susceptible to a low cost of manufacture with regard to both materials and labor, and hence susceptible to low prices of sale to the public and professionals, thereby making such device economically available the buying public.

### SUMMARY OF THE INVENTION

A caulk heater in accordance with the principles of the present invention is capable of providing heat to a caulking gun without relying on external energy sources to operate, allowing the caulk to more positively penetrate cracks and crevices into which the caulking is intended to flow in a manner that is not obtainable in cold weather conditions if the caulk cartridge is not heated. A caulk heater in accordance with the principles of the present invention utilizes a heat source that can easily and expeditiously be replaced to allow continuous or near continuous operation. A caulk heater in accordance with the principles of the present invention is capable of delivering heat to the caulk cartridge received by the caulking gun while the caulk is being dispensed. A caulk heater in accordance with the principles of the present invention better delivers heat more uniformly to the surface area of the caulk cartridge. A caulk heater in accordance with the principles of the preset invention is portable and can be easily transported to various areas of the job site and between job sites. A caulk heater in accordance with the principles of the present invention can be used with caulking guns and caulking cartridges of various types, sizes, and manufacturers. A caulk heater in accordance with the principles of the present invention can be easily and quickly disengaged from the caulking gun to allow for a quick replacement of an empty caulk cartridge with a new caulk cartridge. A caulk heater in accordance with the principles of the present invention is rugged in construction, reliable in operation, and light in weight for either professional or domestic use yet relatively inexpensive to produce.

In accordance with the principles of the present invention, a caulk heater is provided as a heated sleeve that includes multiple layers. A heat transmissive interior surface layer is arranged to engage in a surrounding relationship with a caulking gun containing a caulk cartridge, to facilitate the transfer of heat to the caulk cartridge. The heated sleeve contains at least one pocket shaped and sized to receive standard, commercially available, disposable hand warmers, or a similar material capable of producing heat without reliance on an outside power supply. A heat resistant first exterior surface layer of the caulk heater is made of a heat resistant, insulation material to minimize the loss of heat, and maximize the delivery of heat to the caulking cartridge. A protective second exterior surface layer of the caulk heater can be made out of a durable material to generally protect the caulk heater from excessive wear and tear and from damage. A fastener is provided to removably enclose the caulking gun and the caulk cartridge.

This Summary introduces concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description refers to the following accompanying drawings:

FIG. 1 is a perspective view of a caulking gun, a caulk cartridge, and a heated sleeve in accordance with the principles of the present invention.

FIG. 2 is a perspective view of the caulking gun, the caulk cartridge, and the heated sleeve of FIG. 1 combined.

FIG. 3 is an interior view of the heated sleeve of FIG. 1

FIG. 4 is a perspective view of the caulking gun, the caulk cartridge, and the heated sleeve of FIG. 1 in use.

### DETAILED DESCRIPTION OF THE PREFERRED EMBODIMENTS

In accordance with the principles of the present invention, a caulk heater is provided as a heated sleeve. The heated sleeve is capable of receiving a caulking gun containing a caulk cartridge, and keeping the caulking gun and caulk cartridge warm during operation in intemperate environments. Cold temperatures can cause the caulk in the cartridge to harden or even freeze and may make it difficult for the caulk to be dispensed. Even if the caulk can be dispensed, the cold or freezing surrounding temperature can negatively affect the sealing and bonding properties of the caulk, resulting in a weak and not durable seal or bond. The caulk can also be damaged by cold or freezing temperatures rendering it unusable.

By keeping the caulking gun and the caulk cartridge warm during use, the heated sleeve prevents the caulk from becoming too dense or from hardening, thus allowing it to be readily dispensed from the caulk cartridge. Further, the heated sleeve prevents the cold and freezing temperatures from negatively affecting the sealing and bonding properties of the caulk, helping to ensure that the resulting bond or seal will be strong and durable. Still further, the heated gun sleeve also helps prevent the caulk from damage by freezing, avoiding the loss and waste of the caulk material.

The heated sleeve is sized and shaped to receive a caulking gun containing a caulk cartridge. In one embodiment, the longitudinal dimension of the heated sleeve is preferably substantially equal to the longitudinal dimension of the cartridge housing of the caulking gun. The heated sleeve includes multiple layers, including a heat transmissive interior surface layer, a heat resistant first exterior surface layer, and a protective second exterior surface layer. The heat transmissive interior surface layer is arranged to engage in a surrounding relationship with the caulking gun and the caulk cartridge contained in the caulking gun, to facilitate transfer of heat from the heated sleeve to the caulk cartridge. The heat resistant first exterior surface layer of the heated sleeve is made of a heat resistant, insulation material to minimize the loss of heat generated by the heated sleeve, and to maximize the delivery of heat to the caulk cartridge. The protective second exterior surface layer of the caulk heater can be made of a durable material to generally protect the caulk heater from excessive wear and tear and from damage. The materials comprising the first exterior surface layer, the second exterior surface layer, and the interior surface layer are preferably flexible and lightweight to allow the heated sleeve to easily wrap around the caulking gun, disengage from the caulking gun, and be transported to, from, and around the job site. The materials comprising the first exterior surface layer, the second exterior surface layer, and the interior surface layer are preferably breathable, to permit oxygen to flow between and through the layers to facilitate heat generation by the disposable hand warmer or a similar material capable of producing heat without reliance on an outside power supply

The heated sleeve contains at least one pocket sized to removably receive standard, commercially-available, disposable hand warmers, or other similar heat producing material. In one embodiment, the pockets are sandwiched between the interior surface layer and the first exterior surface layer; however, other configurations or locations of the pockets may be utilized. For example, and not to the exclusion of any other configuration and location, the pockets may be secured to the interior surface layer in such a manner that they are supported within the interior surface layer.

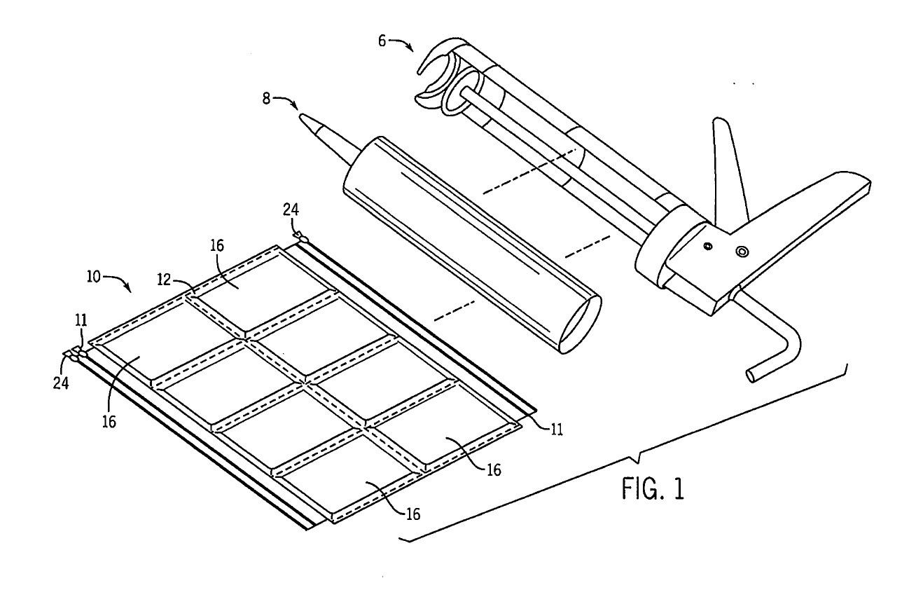

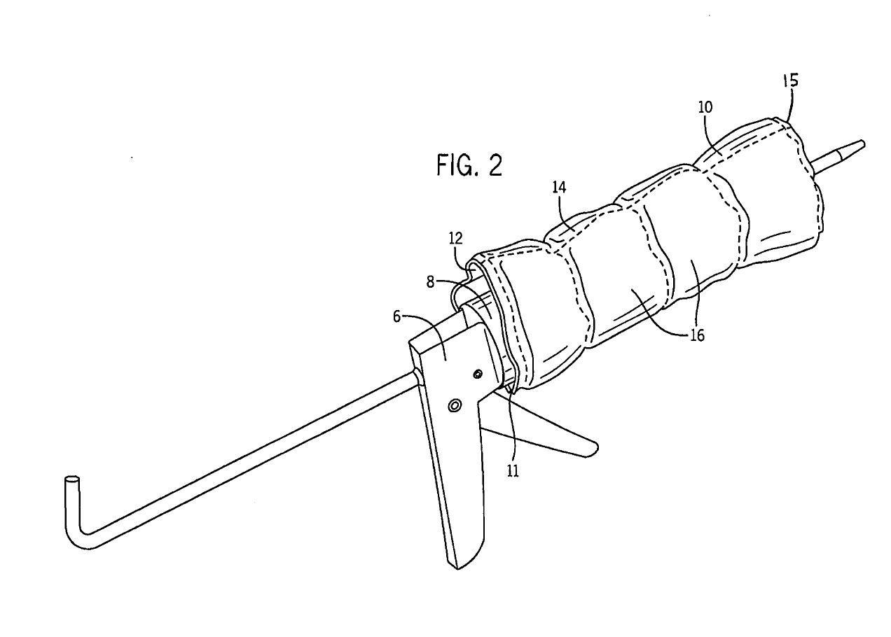

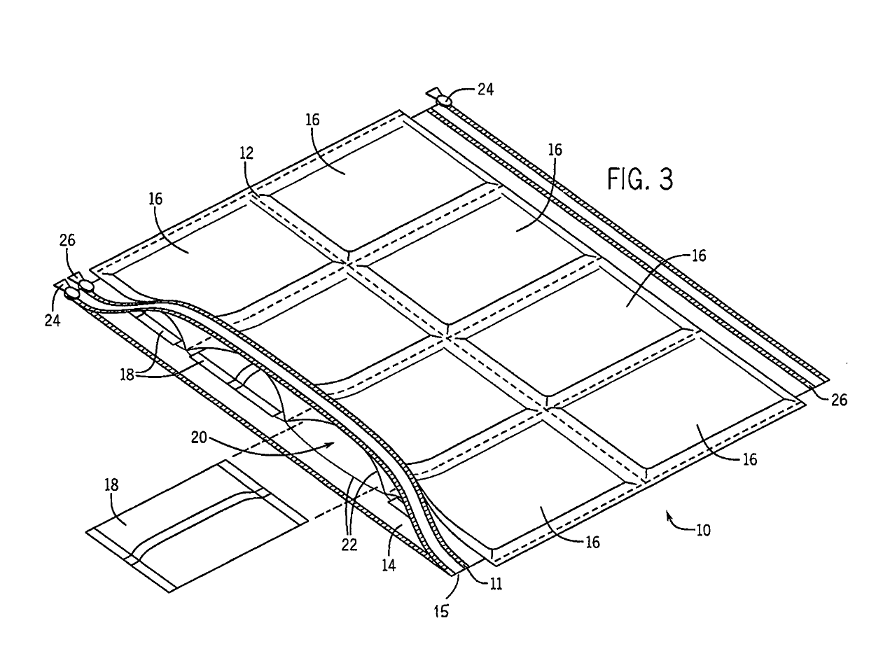

In more detail, referring now to FIG. 1, a caulking gun 6, a caulk cartridge 8, and a heated sleeve 10 in accordance with the principles of the present invention are seen in perspective, unassembled. FIG. 2 shows the caulking gun 6, the caulk cartridge 8, and the heated sleeve 10 of FIG. 1 combined with the caulk cartridge 8 inserted into the caulking gun 6, and the heated sleeve 10 encompassing the caulking gun 6 and the caulk cartridge 8. In FIG. 2, a fastener 11 such as for example a zipper 26 is closed to cause the heated sleeve 10 to encompass the caulk gun 6 and caulk cartridge 8. As best seen in FIG. 3, the fastener 11 is open to reveal the encompassed caulking gun 6 and caulk cartridge 8, when in use.

The heated sleeve 10 includes multiple of layers including an interior surface layer 12, a first exterior surface layer 14, and a second exterior surface layer 15. The interior surface layer 12 is made of a heat transmissive material to facilitate the transfer of heat from the heated sleeve 10 to the caulking cartridge contained in a caulking gun.

FIG. 3 is an interior view of the heated sleeve of FIG. 1. As shown in FIG. 3, the heated sleeve 10 contains at least one pocket 16 shaped and sized to receive standard commercially disposable hand warmers 18, which serve as the source of heat of the heated sleeve 10. While hand warmers 18 may be the preferred source of heat, due to their commercial availability and generally low price, and the fact that they don't rely on AC power supply to produce heat, any similar, preferably commercially available, heat producing material can be utilized. For example, clay pads, granules, stones, or packs could be utilized as the source of heat. Some of these materials may be reusable, by heating them, for example, in a microwave or oven to the desired temperature prior to utilizing them as the source of heat in the heated sleeve 10. If reusable sources of heat are utilized, the user can additionally vary the amount of heat delivered by the heated sleeve 10, by varying the length of time the heat producing material is heated prior to use or reuse. For ease of description, such heat producing devices are non-narrowingly referred to herein a heat bricks.

The pockets 16 are preferably of rectilinear configuration and of size to readily removably receive the heat bricks 18; however, the pockets 16 can be of any configuration, size and number to facilitate the receipt of heat producing material of any configuration, size and shape, for example, material that is larger or smaller than standard heat bricks 18. For example, the number of pockets could be greater in a heated sleeve 10 sized to receive a caulking gun 6 longer than a standard caulking gun, or the number of pockets 16 could be smaller in a heated sleeve 10 sized to receive a caulking gun 6 shorter than a standard caulking gun.

As depicted in FIGS. 1-3, in one embodiment, the pockets are defined between the interior surface layer 12 and the first exterior surface layer 14. Edges 22 of the pockets 16 are formed where the interior surface layer 12 and the first exterior surface layer 14 are stitched or otherwise secured together. Entry into the interior of each pocket 16 is by way of a longitudinal slit 20. A fastener such as for example a zipper 24 may be provided to close the longitudinal slits 20 when the heat bricks are received in the pockets 16, and to open the longitudinal slits 20 to allow the heat bricks to be replaced or otherwise removed from the pockets 16. Different types of fasteners can be utilized to close and open the longitudinal slits 20 in place of a zipper. For example, hook and loop style fasteners can be utilized. Other means of attachment are also possible, including but not limited to tape, bags, buckles, straps, and the like.

Further, any other location of the pockets 16 within the heated sleeve 10 may also be utilized. For example, and not to the exclusion of any other location, the pockets 16 may be secured to the interior surface layer 12 in such a manner that they are supported within the interior surface 12 layer. The first exterior surface layer 14 of the heated sleeve 10 is preferably made of an insulation material that is resistant to passage of heat, to maximize the delivery of heat from the heated sleeve 10 to the caulking gun 6 containing the caulk cartridge 8. The second exterior surface layer 15 of the heated sleeve 10 is preferably made of a durable material to generally protect the heated sleeve 10 from excessive wear and tear and damage. The materials comprising the first exterior layer 14, the second exterior surface layer 15, and the interior surface layer 12, are flexible, to allow the heated sleeve 10 to be easily receive the caulking gun 6 containing a caulk cartridge 8, disengage the caulking gun 6 containing the caulk cartridge 8, and to be transported to, from and around the job site. The materials comprising the first exterior surface layer 14, the second exterior surface layer 15, and the interior surface layer 12 are preferably breathable to allow oxygen to flow through and between the surfaces to permit oxygen to flow between and through the layers to facilitate heat generation by the disposable hand warmer or a similar material capable of producing heat without reliance on an outside power supply.

Again, the heated sleeve 10 has a fastener 11 such as for example a zipper 26 along one side. The fastener 11 can extend from or near to the top edge to or near to the bottom edge of the heated sleeve 10. The fastener 26 is adapted to be slid in one direction to cause the heated sleeve 10 to close, when the caulking gun 6 is received by the heated sleeve 10, and to be slid in the opposite direction to cause the heated sleeve 10 to open, to remove the caulking gun 6 from the heated sleeve 10. Thus, when closed the heated sleeve 10 defines an interior cavity that is sized and shaped to receive a caulking gun 6 containing a caulk cartridge 8. Alternatively, the heated sleeve 10 can be first wrapped around the caulking gun 6 containing the caulk cartridge 8 before the fastener 11 is closed.

However, while in the described embodiment a zipper is depicted any type of fastener can be utilized. For example, hook and loop style fasteners can be utilized instead of a zipper, to close the heated sleeve 10. Other means of attachment are also possible, including but not limited to tape, bags, buckles, straps, and the like.

In one embodiment, the length of the side edge of the heated sleeve 10 is substantially equal to the circumference of the caulking gun 6 containing the caulk cartridge 8. When the heated sleeve 10 is wrapped around the caulking gun 6 and closed, the interior surface layer 12 of the heated sleeve 10 is in a surrounding relationship and preferably in contact with the caulking gun 6 and the caulk cartridge 8 received in the caulking gun 6. Such contact helps maximize the transfer of heat from the heated sleeve 10 to the caulking cartridge 8.

In one embodiment, the first exterior surface layer 14 of the heated sleeve 10 is made of a material that is both durable, to generally protect the heated sleeve 10 from excessive wear and tear, and resistant to passage of heat, to maximize the delivery of heat from the heated sleeve 10 to the caulking gun 6 containing the caulk cartridge 8. Such embodiment does not comprise the second exterior surface layer.

The heated sleeve 10 can be of various sizes to be adapted to caulking guns 6 of various sizes. A heated sleeve 10 used with larger than standard sized caulking gun 6, will have a longer side edge than a heated sleeve 10 adapted to be used with a standard sized caulking gun 6. Similarly, the heated sleeve 10 to be used with a smaller caulking gun 6 will have a side edge that is shorter.

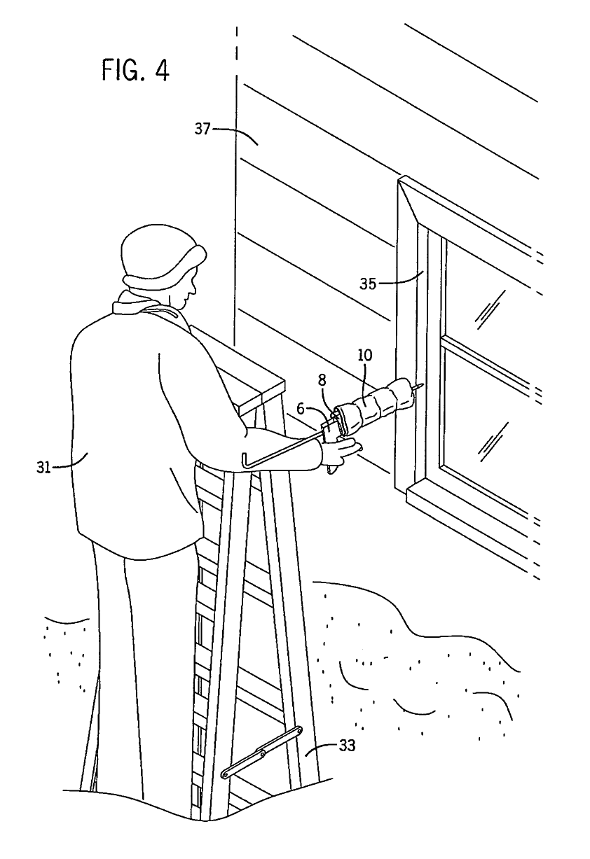

FIG. 4 is a perspective view of the caulking gun, the caulk cartridge, and the heated sleeve of FIG. 1 in use. A user 31 is seen on a ladder 33 caulking a window 35 on the second floor of a building 37. The heated sleeve 10 is provided wrapped around a caulking gun 6 containing a caulk cartridge 8, with the fastener 11 closed such that the heated sleeve is closed 10. Ease of use of the caulking gun 6 and cartridge 8 encompassed within the heated sleeve 10 is seen as the user 31 has no trouble navigating the ladder 33 and caulking the second floor window 35 while maintaining the heated temperature of the caulk.

The heated sleeve 10 also provides heat to the caulking gun without relying on external energy sources to operate, allowing the caulk to more positively penetrate cracks and crevices into which the caulking is intended to flow in a manner that is not obtainable in cold weather conditions. The heated sleeve 10 utilizes a heat source that can easily and expeditiously be replaced to allow continuous operation. The heated sleeve 10 delivers heat directly to the caulk cartridge received by the caulking gun while the caulk is being dispensed. The heated sleeve 10 delivers heat uniformly to the surface area of the caulk cartridge. The heated sleeve 10 can be easily transported to various areas of the job site and between job sites. The heated sleeve 10 can be quickly disengaged from the caulking gun to allow for a quick replacement of an empty caulk cartridge with a new caulk cartridge. The heated sleeve 10 is rugged in construction, reliable in operation, and light in weight yet relatively inexpensive to produce.

Although the subject matter has been described with a specific implementation, other alternatives, modifications, and variations will be apparent to those skilled in the art. Accordingly, the disclosure is intended to be illustrative, but not limiting, and all such alternatives, modifications, and variations are within the spirit and scope of the following claims.

What is claimed is:

1. A caulk heater for use with a caulking gun containing a caulk cartridge, the caulk heater comprising:
a heat transmissive interior surface layer arranged to engage in a surrounding relationship with the caulking gun and the caulk cartridge;
an exterior surface layer made of a heat resistant, insulation material;
at least one pocket shaped and sized to receive at least one heat brick; and
a fastener to removably enclose the caulking gun and the caulk cartridge.

2. The caulk heater of claim 1, further containing a second exterior surface layer made of a durable material.

3. The caulk heater of claim 2, further wherein the first exterior surface layer, the second exterior surface layer, and the interior surface layer are made of flexible and lightweight material.

4. The caulk heater of claim 2, further wherein the first exterior surface layer, the second exterior surface layer, and the interior surface layer are breathable.

5. The caulk heater of claim 1, further wherein the exterior surface layer and the interior surface layer are breathable.

6. The caulk heater of claim 1, wherein the fastener comprises a zipper extending from a top edge to a bottom edge of the caulk heater, the zipper adapted to be slid in one direction to cause the heated sleeve to be closed and to be slid in an opposite direction to cause the heated sleeve to open, to remove the caulking gun from the heated sleeve.

7. The caulk heater of claim 1, wherein a length of a side edge of the heated sleeve is substantially equal to a circumference of the caulking gun containing the caulk cartridge.

8. The caulk heater of claim 1, wherein the pockets are sandwiched between the interior surface layer and the exterior surface layer, with edges of the pockets formed by the interior surface layer and the exterior surface layer being secured together.

9. The caulk heater of claim 8, further containing a fastener to open and close a longitudinal slit of each pocket.

10. The caulk heater of claim 1, wherein the pockets are secured to the heat transmissive interior surface layer in such manner that the pockets are supported within the heat transmissive interior surface layer.

11. The caulk heater of claim 1, wherein the heat bricks are selected from the group consisting of hand warmers, clay pads, granules, stones, packs, and combinations thereof.

12. The caulk heater of claim 1, wherein the heat bricks are reusable.

13. The caulk heater of claim 1, wherein a longitudinal dimension of the heated sleeve is substantially equal to a longitudinal dimension of a caulking gun cartridge housing the caulking gun.

14. The caulk heater of claim 1, wherein the heat transmissive interior layer and the exterior surface layer are made of flexible and lightweight material.

15. A caulk heater for use with a caulking gun containing a caulk cartridge, the caulk heater comprising:
an interior surface layer arranged to engage in an at least partially surrounding relationship with the caulking gun and the caulk cartridge;
an exterior surface layer made of a heat resistant material;
at least one pocket shaped and sized to receive at least one heat brick,
a heat brick disposed in the pocket, the heat brick capable of producing heat; and
a fastener adapted to removably enclose the caulking gun and the caulk cartridge.

16. The caulk heater of claim 15, further containing a second exterior surface layer made of a durable material.

17. The caulk heater of claim 15, wherein the heat brick consists of material capable of producing heat without reliance on outside energy sources, such as a commercially available hand warmer.

18. The caulk heater of claim 15, wherein the heat brick is made of a reusable material capable of producing varying levels of heat.

19. A caulk heater for use with a caulking gun containing a caulk cartridge, the caulk heater comprising:
a heat transmissive interior surface layer;
a first exterior surface layer made of a heat resistant, insulation material;
a second exterior surface layer made of a durable material;
at least one pocket shaped and sized to receive at least one heat brick, the first exterior surface layer, the second exterior surface layer and the interior surface layer being breathable; and
a fastener to removably enclose the caulking gun and the caulk cartridge;

20. The caulk heater of claim 19, further wherein the first exterior surface layer, the second exterior surface layer, and the interior surface layer are breathable.

21. The caulk heater of claim 19, further wherein the heat transmissive interior surface layer is arranged to engage in a surrounding relationship with the caulking gun and the caulk cartridge.
